(19) United States
(12) Patent Application Publication
(10) Pub. No.: US 2023/0282003 A1
(43) Pub. Date: Sep. 7, 2023

(54) Environment Recognition System and Environment Recognition Method

(71) Applicant: Hitachi, Ltd., Chiyoda-ku, Tokyo (JP)

(72) Inventors: Shigeru MATSUO, Tokyo (JP); Masahiro KIYOHARA, Tokyo (JP); Hideaki KIDO, Tokyo (JP)

(21) Appl. No.: 18/017,262

(22) PCT Filed: Apr. 19, 2021
(86) PCT No.: PCT/JP2021/015793

§ 371 Date: Jan. 20, 2023

(30) Foreign Application Priority Data
Jul. 31, 2020 (JP) 2020-130521

(51) Int. Cl. G06V 20/58; G06V 10/25; G01C 21/00

(52) U.S. Cl. CPC G06V 20/58; G06V 10/25; G01C 21/3804; G06V 2201/07

(57) ABSTRACT

Provided is an external environment recognition system which complements a blind spot of an on-board camera occurring due to a moving obstacle such as a preceding vehicle with a photographed image obtained from an on-road camera, and can generate a detailed map for automatic traveling. To this end, the external environment recognition system composites a photographed image from an on-board camera with a photographed image from an external camera to recognize the environment outside the host vehicle, the external environment recognition system comprising: an on-board camera which photographs an area in front of the host vehicle; an on-board communication unit which communicates with the external camera; a front moving body detection unit which detects a moving body in the front area on the basis of the photographed image from the on-board camera; a blind spot extraction unit which extracts a blind spot caused by the moving body; an image conversion unit which converts the received photographed image from the external camera into a viewpoint of the on-board camera; an image compositing unit which composites the viewpoint conversion image from the image conversion unit with the blind spot of the photographed image from the on-board camera; and a detailed map generation unit which generates a detailed map in the traveling direction of the host vehicle on the basis of the composited image from the image compositing unit.

### TECHNICAL FIELD

The present invention relates to an environment recognition system and an environment recognition method for generating a detailed map of a route of a vehicle.

### BACKGROUND ART

A self-driving vehicle that automatically runs in places such as roads and warehouses reaches its destination by taking a preset route. However, temporary obstacles such as parked vehicles and fallen trees on the road are not included in map information used in setting a route, and, when the map information is old, the map information may represent the structures of roads differently from the actual ones. Therefore, it is not possible to make sure that the vehicle can actually take the route set using the map information. In addition, when the map information used in setting the route is a simplified map where road structures are represented as nodes and links, there is a possibility that the areas of the roads where the vehicle can take (e.g., the road width and the number of lanes) are not recorded precisely, so that it is not possible to determine where the vehicle is to run in a wide road, in advance. Therefore, an actual self-driving vehicle needs to detect an area that is drivable around a subject vehicle, using an onboard camera or an onboard environment recognition sensor such as LiDAR, and determine its course, while generating a detailed map around the subject vehicle in real time.

Having been known as this type of self-driving vehicle is a vehicle that detects information of the road where the vehicle is heading in places where visibility is poor, e.g., before a curve or an intersection, by using an image captured by a traffic camera. For example, PTL 1 discloses a vehicle vision assistance system that obtains an image corresponding to a blind spot from a camera at an intersection (hereinafter, referred to as a “traffic camera”). FIG. 7 in PTL 1, for example, discloses a method for complementing the image of a blind spot by converting an image captured by a traffic camera into an image from the viewpoint of an onboard camera, and synthesizing the resultant image with an image captured by the onboard camera.

In this literature, it is assumed that the blind spot of the onboard camera is formed by a fixed obstacle (e.g., a building) the relative position of which with respect to the traffic camera remains unchanged. Assuming that there is a vehicle at a predetermined position, it is possible to identify the area corresponding to the blind spot of the camera onboard the vehicle, from an image captured by the traffic camera. Therefore, it is not particularly difficult for the traffic camera to transmit the image corresponding to the blind spot of the onboard camera of the vehicle, autonomously, to the vehicle that located at the predetermined position from the viewpoint of the traffic camera (see, for example, 5235 in FIG. 5 of the same literature).

### CITATION LIST

### Patent Literature

PTL 1: JP 2009-70243 A

### SUMMARY OF INVENTION

### Technical Problem

When there is a preceding vehicle ahead of a self-driving vehicle that generates a detailed map in real time using an onboard camera, the road surface ahead of the preceding vehicle becomes the blind spot for the onboard camera. Therefore, there is a problem that the self-driving vehicle cannot generate a detailed map of the road head of the preceding vehicle, and cannot determine the course ahead of the preceding vehicle.

It might be possible to apply PTL 1 to such a problem if a traffic camera can also transmit the image of such a blind spot autonomously. However, not only a relative position and a relative speed between a preceding vehicle (moving obstacle) and the subject vehicle change from moment to moment, and but also the size of the vehicle body of the preceding vehicle (full length, full width, full height, shape, etc.) is not constant. Therefore, it is extremely difficult for a traffic camera to identify the blind spot of the onboard camera and to transmit the image corresponding to the blind spot to the self-driving vehicle autonomously.

Therefore, an object of the present invention is to provide an environment recognition system capable of generating a detailed map for self-driving, by complementing a blind spot of an onboard camera, the blind spot being formed by a moving obstacle such as a preceding vehicle, with an image captured by the traffic camera.

### Solution to Problem

Features of the present invention for solving the above problems are, for example, as follows. An environment recognition system that recognizes an environment external to a subject vehicle by synthesizing an image captured by an onboard camera with an image captured by an external camera, the environment recognition system including: the onboard camera that captures an image in front of the subject vehicle; an onboard communicating unit that communicates with the external camera; a front moving object detecting unit that detects a moving object in front, based on the image captured by the onboard camera; a blind spot extracting unit that extracts a blind spot created by the moving object; an image converting unit that converts an image captured by and received from the external camera into an image from a viewpoint of the onboard camera; an image synthesizing unit that synthesizes the image having the viewpoint converted by the image converting unit, to the blind spot included in the image captured by the onboard camera; and a detailed map generating unit that generates a detailed map of a direction ahead of the subject vehicle based on the image synthesized by the image synthesizing unit.

### Advantageous Effects of Invention

With the environment recognition system according to the present invention, it is possible to smoothly determine a drivable area of a road surface by complementing a blind spot of an onboard camera, formed by a moving obstacle, such as a preceding vehicle, with an image captured by a traffic camera, and generating a detailed map for self-driving. Problems, configurations, and effects other than those described above will be clarified by the following description of embodiments.

### BRIEF DESCRIPTION OF DRAWINGS

FIG. 1 is a system configuration diagram of an environment recognition system and a traffic camera according to a first embodiment.

FIG. 2 is a diagram illustrating arrangement of vehicles and traffic cameras at an intersection.

FIG. 3 is an example of an image of an onboard camera when a preceding vehicle creates a blind spot on the road surface where the vehicle is heading.

FIG. 4 is an example of an image from a traffic camera captured at the same time as in FIG. 3.

FIG. 5 is an example of an image resultant of complementing the blind spot in the image of the onboard camera, with the image of the traffic camera.

FIG. 6 is a flowchart of an operation performed by the environment recognition system.

FIG. 7 is a system configuration diagram of an environment recognition system and a traffic camera according to a second embodiment.

FIG. 8 is an example of an image resultant of complementing a blind spot on a road surface, using a plurality of traffic camera images.

FIG. 9 is a system configuration diagram of an environment recognition system and a traffic camera according to a third embodiment.

### DESCRIPTION OF EMBODIMENTS

Some embodiments of an environment recognition system according to the present invention will now be explained using drawings and the like. Note that the following description provides specific examples of the content of the present invention, and the present invention is not limited to these descriptions. Various changes and modifications may be made by those skilled in the art within the scope of the technical idea disclosed in the present specification. Across all of the drawings for explaining the present invention, components having the same function are denoted by the same reference numerals, and redundant explanations thereof are sometimes omitted.

### First Embodiment

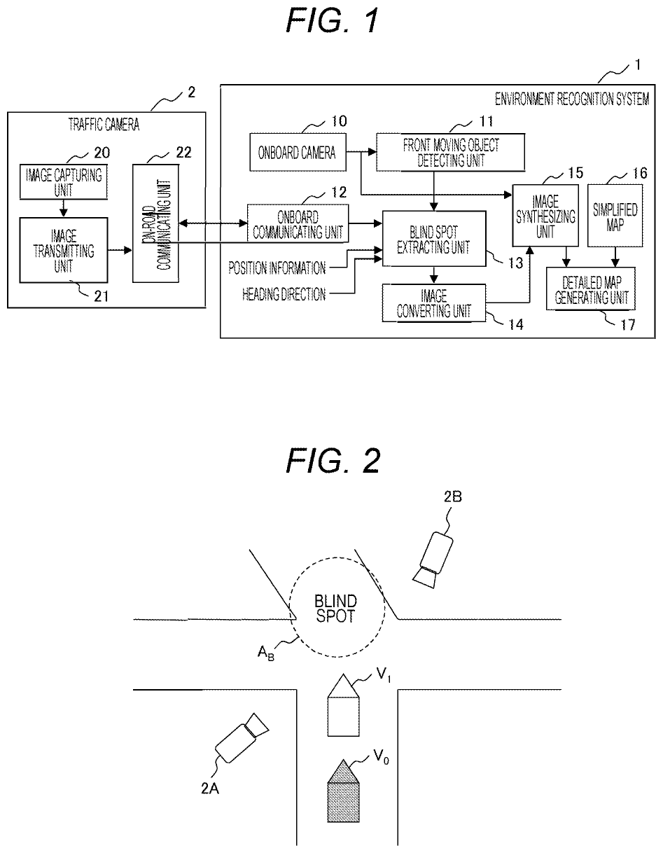

To begin with, an environment recognition system 1 according to a first embodiment of the present invention will be explained with reference to FIGS. 1 to 6.

FIG. 1 is a system configuration diagram illustrating a configuration of an environment recognition system 1 onboard a self-driving vehicle V₀, and a traffic camera 2 installed near an intersection, for example. Note that the environment recognition system 1 is connected to a vehicle control device, not illustrated. The vehicle control device controls a driving system, a braking system, and a steering system of the self-driving vehicle V₀ using a detailed map generated by the environment recognition system 1.

<Traffic Camera 2>

The traffic camera 2 is an external camera installed near an intersection, and includes an image capturing unit 20, an image transmitting unit 21, and an on-road communicating unit 22. The image capturing unit 20 is a monocular camera or a stereo camera for capturing an image of a road. The image transmitting unit 21 is a computer that generates transmission data by applying a lossless compression to an image captured by the image capturing unit 20 and parameters of the camera at the time when the image is captured, upon request from the environment recognition system 1. The camera parameters include internal parameters such as an angle of view, the number of pixels, and a focal length, and external parameters such as a camera position, a height from a road, and a viewpoint direction. The on-road communicating unit 22 is a communication device for transmitting the transmission data to the environment recognition system 1.

<Environment Recognition System 1>

The environment recognition system 1 is an onboard system for recognizing an external environment of the self-driving vehicle V₀, and detects obstacles and generates a detailed map to be used in determining a course of the self-driving vehicle V₀. As mentioned earlier, in order to implement self-driving, it is necessary to keep determining a passable area of the road. Therefore, as a precondition, the environment recognition system 1 keeps recognizing the shape of the road surface based on the image captured by the onboard camera 10. Therefore, when a blind spot is formed by a moving obstacle, such as a preceding vehicle V₁, the environment recognition system 1 according to the present embodiment complements the blind spot by clipping a part of an image captured by the traffic camera 2, and synthesizing the image with an image captured by the onboard camera 10. The environment recognition system 1 then keeps determining the passable area of the road and creating a detailed map, based on the synthesized image.

As illustrated in FIG. 1, the environment recognition system 1 includes an onboard camera 10, a front moving object detecting unit 11, an onboard communicating unit 12, a blind spot extracting unit 13, an image converting unit 14, an image synthesizing unit 15, a simplified map 16, and a detailed map generating unit 17. Note that the environment recognition system 1 is, specifically, a computer including hardware examples of which include a processor such as a CPU, a main memory such as a semiconductor memory, an auxiliary memory, and a communication device. The processor then executes a program having been loaded onto the main memory to implement each of the above-described functions. However, hereinafter, descriptions will be made by omitting the explanations of such well-known technologies as appropriate.

The onboard camera 10 is a monocular camera or a stereo camera for capturing an image of a direction in which the vehicle is heading. The front moving object detecting unit 11 detects a moving obstacle, such as a vehicle or a pedestrian, from an image captured by the onboard camera 10. The onboard communicating unit 12 is a communication device for communicating with the traffic camera 2. The blind spot extracting unit 13 extracts an image that is to be used for complementing the blind spot of the captured image of the onboard camera 10, from an image captured by the traffic camera 2. The image converting unit 14 performs viewpoint conversion to the image extracted by the blind spot extracting unit 13, in a manner suitable to the viewpoint of the onboard camera 10. The image synthesizing unit 15 synthesizes the image captured by the onboard camera 10 with the image corresponding to the blind spot, resultant of the viewpoint conversion of the image converting unit 14. The detailed map generating unit 17 generates a detailed map representing the details of a drivable area based on the image synthesized by the image synthesizing unit 15, and on the simplified map 16. Note that, in the simplified map 16, nodes and links indicating road structures, and camera parameters of the traffic cameras 2 at different locations (e.g., the locations where the cameras are installed, the ranges captured by the cameras) are recorded.

<Specifics of Processing Performed by Environment Recognition System 1>

Specifics of processing performed by the environment recognition system 1 in a specific situation will now be explained with reference to FIGS. 2 to 5.

FIG. 2 is an example of traffic at a certain time at an intersection where two traffic cameras 2A and 2B are installed facing each other diagonally. In this example, the vehicle V₁ is going ahead of the self-driving vehicle V₀ that is equipped with the environment recognition system 1, and the vehicle V₁ is about to enter the intersection. As illustrated in this drawing, with the line of sight of the onboard camera 10 of the self-driving vehicle V₀ being blocked by the vehicle V₁, the environment recognition system 1 of the self-driving vehicle V₀ cannot recognize the blind spot AB and thus cannot determine a course ahead of the intersection.

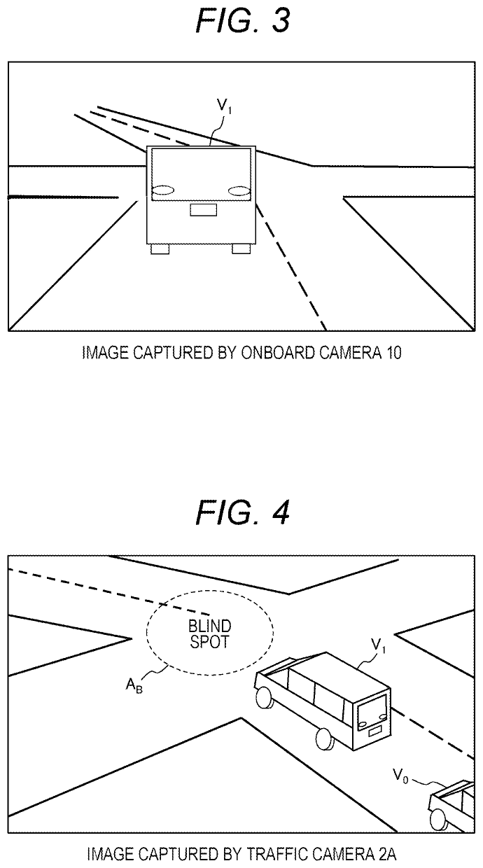

FIG. 3 is an example of an image captured by the onboard camera 10 in the self-driving vehicle V₀ in FIG. 2. As illustrated herein, the onboard camera 10 cannot capture an image of the road surface in front of the vehicle V₁ (blind spot AB in FIG. 2). Therefore, in order to generate a detailed map of the blind spot AB before passing through this spot, it is necessary to take a measure such as keeping a greater distance from the vehicle V₁ before entering the intersection so as to allow the road surface ahead of the intersection to appear in the view of the onboard camera 10. However, when such a measure is taken, the self-driving vehicle V₀ decelerates, so that there is a problem that the vehicle fails to self-drive smoothly.

On the contrary, FIG. 4 is an example of an image captured by the traffic camera 2A capable of capturing an image in the direction toward which the self-driving vehicle V₀ is heading. As is clear from the drawing, the road surface including the blind spot AB, which is a blind spot of the onboard camera 10, is captured in the image captured by the traffic camera 2A. Therefore, the environment recognition system 1 requests transmission of the captured image from the traffic camera 2A that is near the viewpoint direction of the onboard camera 10 installed in the self-driving vehicle V₀. When the environment recognition system 1 receives the captured image from the traffic camera 2A, the blind spot extracting unit 13 extracts, to begin with, an image including the blind spot AB, and then the image converting unit 14 performs a viewpoint conversion of the extracted image in a manner suitable for the viewpoint of the onboard camera 10. Note that the reason why the environment recognition system 1 requests a captured image not from the traffic camera 2B but from the traffic camera 2A is that, by using the captured image of the traffic camera 2A that is closer to the viewpoint of the onboard camera 10, the amount processing by the image converting unit 14 is reduced, and deterioration of the image quality can be suppressed.

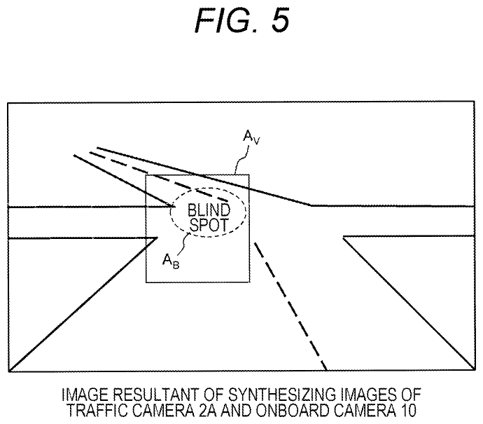

FIG. 5 is an example of a synthesized image generated by the image synthesizing unit 15 in the environment recognition system 1, and is an image obtained by replacing an area corresponding to the vehicle V₁ in the image (FIG. 3) captured by the onboard camera 10, with the image (FIG. 4) resultant of the viewpoint conversion by the image converting unit 14. By generating such a synthesized image, the detailed map generating unit 17 can generate a detailed map for the intersection that is the blind spot of the vehicle V₁, and the vehicle control device can determine a route for passing the intersection based on the detailed map.

<Flowchart of Environment Recognition System 1>

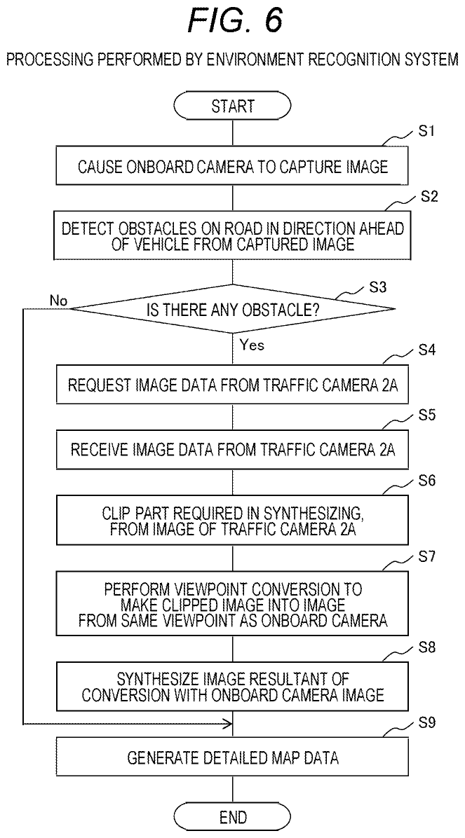

Processing by the environment recognition system 1 will now be explained sequentially with reference to the flowchart in FIG. 6.

To begin with, in step S1, the onboard camera 10 captures an image on the front side. In step S2, the front moving object detecting unit 11 detects an obstacle on the road in the direction in which the vehicle is heading, from the image captured by the onboard camera 10. As an example, the vehicle V₁ in FIG. 3 is detected as an obstacle. In step S3, the front moving object detecting unit 11 determines whether there is any obstacle. If there is any obstacle, the front moving object detecting unit 11 determines that there is a blind spot on the road ahead, and shifts the process to step S4. By contrast, if there is no obstacle, it is determined that there is no blind spot on the road ahead, and the process is shifted to step S9.

If there is a blind spot on the road, the environment recognition system 1 requests a captured image from the traffic camera 2A in step S4. Note that, because the camera parameters (position, orientation, and the like) of each traffic camera are specified in the simplified map 16, the environment recognition system 1 can request a captured image from the traffic camera 2A that is closer to the line of sight of the onboard camera 10, based on the current position of the self-driving vehicle V₀ and the simplified map 16.

In step S5, the environment recognition system 1 then receives the captured image from the traffic camera 2A. Then, in step S6, the blind spot extracting unit 13 extracts the part required in synthesizing, from the received captured image. In step S7, the image converting unit 14 performs viewpoint converting processing for converting the image extracted by the blind spot extracting unit 13 into an image from the same viewpoint as the onboard camera 10. In the viewpoint converting processing herein, the image size is converted in such a manner that the internal parameters of the traffic camera 2A are mapped to the internal parameters of the onboard camera 10, and then the viewpoint conversion of the image of the traffic camera 2A is performed in such a manner that the external parameters of the traffic camera 2A are matched to the external parameters of the onboard camera 10. The viewpoint converting processing is performed using a known method such as the method described in PTL 1. In step S8, the image synthesizing unit 15 then synthesizes the image having the viewpoint transformed by the image converting unit 14 to the image captured by the onboard camera 10.

Finally, in step S9, if there is no obstacle, the detailed map generating unit 17 generates detailed map data using the image captured by the onboard camera 10. If there is some obstacle, the detailed map generating unit generates a detailed map using the image synthesized by the image synthesizing unit 15 (see FIG. 5). As a method for generating the detailed map, for example, a method described in Japanese Patent Application No. 2019-054649 may be used. In the method disclosed in this literature, information of a group of three-dimensional points is generated by a stereo camera, as an example of a camera. However, in this embodiment, an example in which a monocular camera is used will be explained. An example of a known technique for generating three-dimensional point group information using a monocular camera includes structure from motion (SfM).

With the environment recognition system 1 according to the present embodiment described above, even if the vehicle V₁ driving ahead of the subject vehicle creates a blind spot on the road surface in the direction where the subject vehicle is heading, it is possible to create a synthesized image with no blind spot by synthesizing the image captured by the traffic camera 2 with the image captured by the onboard camera 10, so that it is possible to smoothly create a detailed map for the use of determining a route.

### Second Embodiment

An environment recognition system according to a second embodiment of the present invention will now be explained. Redundant explanations of parts that are common with those in the first embodiment will be omitted.

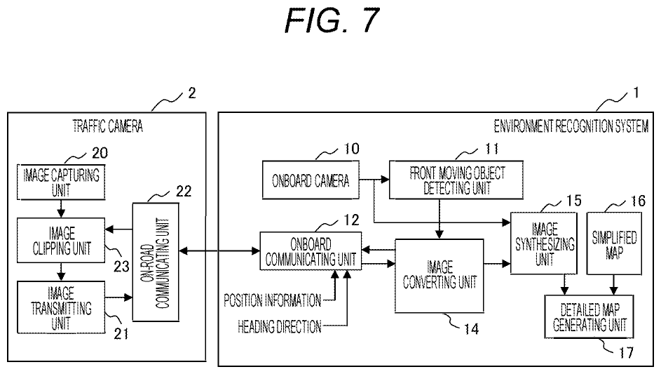

In the first embodiment, the environment recognition system 1 requests a transmission of the entire captured image from the traffic camera 2, and the blind spot extracting unit 13 in the environment recognition system 1 extracts a needed area from the image captured by the traffic camera 2. By contrast, in the present embodiment, the environment recognition system 1 requests the traffic camera 2 to clip the part needed by the environment recognition system 1 from the captured image and to transmit only the part. In this example, the blind spot extracting unit 13 is not required in the environment recognition system 1, so that the blind spot extracting unit 13 is omitted in the environment recognition system 1 in FIG. 7.

In order to cause the traffic camera 2 to clip the image required in the environment recognition system 1, in the present embodiment, when the front moving object detecting unit 11 in the environment recognition system 1 detects the vehicle V₁, the front moving object detecting unit 11 determines the position and the size of the vehicle V₁, from the image captured by the onboard camera 10. The image converting unit 14 in the environment recognition system 1 then converts the position and the size of the vehicle V₁ in the image captured by the onboard camera 10, into the coordinates and the size of the image captured by the traffic camera 2. When transmitting a request for an image to the traffic camera 2, the onboard communicating unit 12 also transmits the coordinates and the size of the image, as the position of where the image is to be clipped.

When the on-road communicating unit 22 in the traffic camera 2 receives the information from the onboard communicating unit 12, the image clipping unit 23 clips the image based on the image clipping range received from the environment recognition system 1. The clipped image is then sent to the onboard communicating unit 12 in the environment recognition system 1, via the image transmitting unit 21.

In this manner, the environment recognition system 1 receives the image having been clipped on the side of the traffic camera 2, then causes the image converting unit 14 to perform viewpoint conversion so as to match the viewpoint to that of an image of the onboard camera 10, and causes the image synthesizing unit 15 to synthesize the images.

As described above, with the environment recognition system 1 according to the present embodiment, it is possible to reduce the amount of data transmitted from the traffic camera 2 to the environment recognition system 1 advantageously, in addition to the effects achieved by the first embodiment.

### Third Embodiment

An environment recognition system according to a third embodiment of the present invention will now be explained. Redundant explanations of parts that are common with those in the embodiments described above will be omitted.

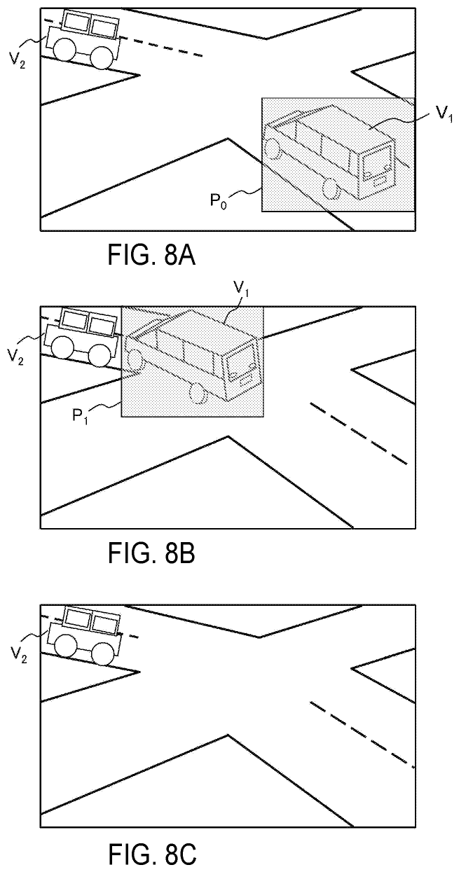

FIG. 8 illustrates a method of generating an image in which a blind spot of a road surface is eliminated using a plurality of images captured by one traffic camera 2, captured at different points in time. FIG. 8(a) is an image captured by the traffic camera 2A in FIG. 2 at a certain point in time, and is an image in which the vehicle V₁ is positioned immediately prior to entering the intersection. This image lacks the road surface of a portion P₀ where the vehicle V₁ is positioned. In addition, FIG. 8(b) is an image immediately after the vehicle V₁ has passed through the intersection, and lacks the road surface of a portion P₁ where the vehicle V₁ is positioned.

Therefore, in the present embodiment, an image resultant of deleting the portion P₀ from FIG. 8(a) and the image resultant of deleting the portion P₁ from FIG. 8(b) are combined to generate a synthesized image illustrated in FIG. 8(c) that does not include the vehicle V₁.

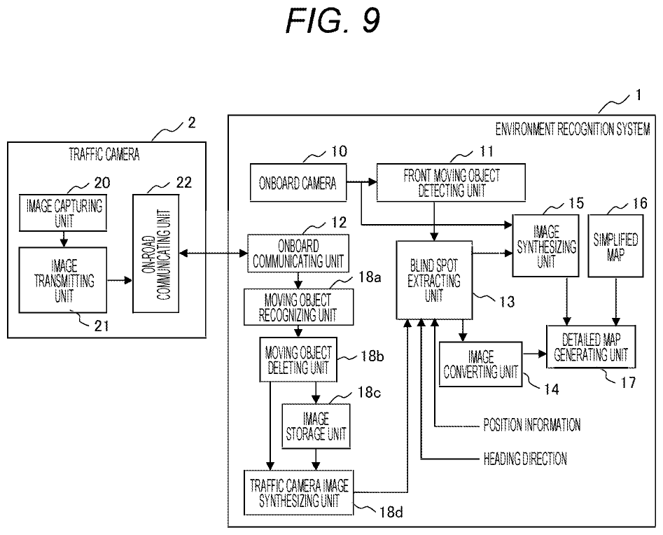

FIG. 9 is a configuration diagram of the environment recognition system 1 according to the present embodiment used in generating the synthesized image illustrated in FIG. 8(c), and is a configuration in which a moving object recognizing unit 18a, a moving object deleting unit 18b, an image storage unit 18c, and a traffic camera image synthesizing unit 18d are provided additionally to the configuration according to the first embodiment illustrated in FIG. 1.

In the environment recognition system 1 according to the present embodiment, to begin with, the moving object recognizing unit 18a determines the position and size of the driving vehicle V₁ in the captured image received from the traffic camera 2. The moving object deleting unit 18b then deletes the image of the detected vehicle V₁, and stores the image having no part corresponding to the vehicle V₁, in the image storage unit 18c. Because a plurality of images are received from the traffic camera 2, the same processing is applied to each of such images. The traffic camera image synthesizing unit 18d then generates synthesized images without the vehicle V₁, by synthesizing the images captured at different points in time and having the vehicle V₁ deleted. The processing after the synthesized images are input to the blind spot extracting unit 13 is the same as that according to the first embodiment.

Even if there is a parked vehicle V₂ on the road, the moving object deleting unit 18b does not delete the parked vehicle V₂ that is not a moving object from the image. Therefore, the parked vehicle V₂ remains in the synthesized image where the vehicle V₁ has been deleted, and when the detailed map generating unit 17 generates a detailed map using the synthesized image, the parked vehicle V₂ is incorporated in the detailed map. As a result, the part where the parked vehicle V₂ is parked can be excluded from the area where the self-driving vehicle V₀ is permitted to drive.

As described above, with the environment recognition system 1 according to the present embodiment, even when the traffic is heavy and each one of the images captured by the traffic camera 2 has many blind spots due to the vehicles, it is possible to generate a captured image from the viewpoint of the traffic camera 2 with no blind spot created by the passing vehicles, by combining a large number of captured images captured at different points in time. In addition, because the parked vehicle V₂ remains in the synthesized image according to the present embodiment, the self-driving vehicle V₀ determining its course using the synthesized image can drive while avoiding the parked vehicle V₂.

### REFERENCE SIGNS LIST

1 environment recognition system
10 onboard camera
11 front moving object detecting unit
12 onboard communicating unit
13 blind spot extracting unit
14 image converting unit
15 image synthesizing unit
16 simplified map
17 detailed map generating unit
18a moving object recognizing unit
18b moving object deleting unit
18c image storage unit
18d traffic camera image synthesizing unit
2, 2A, 2B traffic camera
20 image capturing unit
21 image transmitting unit
22 on-road communicating unit
23 image clipping unit
AB blind spot
V₀ self-driving vehicle
V₁ vehicle
V₂ parked vehicle
20 image capturing unit
21 image transmitting unit
22 on-road communicating unit
23 image clipping unit

1. An environment recognition system that recognizes an environment external to a subject vehicle by synthesizing an image captured by an onboard camera with an image captured by an external camera, the environment recognition system comprising:
the onboard camera that captures an image in front of the subject vehicle;
an onboard communicating unit that communicates with the external camera;
a front moving object detecting unit that detects a moving object in front, based on the image captured by the onboard camera;
a blind spot extracting unit that extracts a blind spot created by the moving object;
an image converting unit that converts an image captured by and received from the external camera into an image from a viewpoint of the onboard camera;
an image synthesizing unit that synthesizes the image having the viewpoint converted by the image converting unit, to the blind spot included in the image captured by the onboard camera; and
a detailed map generating unit that generates a detailed map of a direction ahead of the subject vehicle based on the image synthesized by the image synthesizing unit.

2. An environment recognition system that recognizes an environment external to a subject vehicle by synthesizing an image captured by an onboard camera with an image captured by an external camera, the environment recognition system comprising:
the onboard camera that captures an image in front of the subject vehicle;
an onboard communicating unit that communicates with the external camera;
a front moving object detecting unit that detects a moving object in front, based on the image captured by the onboard camera;
an image converting unit that requests transmission of a captured image corresponding to a blind spot created by the moving object from the external camera, and that converts an image captured by and received from the external camera into an image from a viewpoint of the onboard camera;
an image synthesizing unit that synthesizes the image having the viewpoint converted by the image converting unit, to the blind spot included in the image captured by the onboard camera; and
a detailed map generating unit that generates a detailed map of a direction ahead of the subject vehicle based on the image synthesized by the image synthesizing unit.

3. The environment recognition system according to claim 1, wherein
the onboard communicating unit receives a plurality of captured images captured at different points in time from the external camera, and
the environment recognition system further comprises:
a moving object recognizing unit that recognizes a moving object in the received plurality of captured images;
a moving object deleting unit that deletes the moving object from the received plurality of captured images; and
an external camera image synthesizing unit that synthesizes an image without the moving object by synthesizing the captured images resultant of deleting the moving object.

4. The environment recognition system according to claim 1, wherein, when there are a plurality of external cameras available, the image converting unit uses a captured image of an external camera closer to the viewpoint of the onboard camera as an image to be processed.

5. The environment recognition system according to claim 3, wherein, when there are a plurality of external cameras available, the moving object recognizing unit uses a captured image captured by an external camera closest to the viewpoint of the onboard camera as an image to be processed.

6. An environment recognition method by which an external environment of a subject vehicle is recognized by synthesizing an image captured by an onboard camera with an image captured by an external camera, the environment recognition method comprising:
a step of detecting a moving object in front based on the image captured by the onboard camera;
a step of extracting a blind spot created by the moving object;
a step of converting the image captured by the external camera into an image from a viewpoint of the onboard camera;
a step of synthesizing the image having the viewpoint converted, to the blind spot included in the image captured by the onboard camera; and
a step of generating a detailed map of a direction ahead of the subject vehicle based on the synthesized image.

7. The environment recognition system according to claim 2, wherein, when there are a plurality of external cameras available, the image converting unit uses a captured image of an external camera closer to the viewpoint of the onboard camera as an image to be processed.
